(19) United States
(12) Patent Application Publication
(10) Pub. No.: US 2008/0228783 A1
(43) Pub. Date: Sep. 18, 2008

(54) Data Partitioning Systems

(76) Inventor: Dawn Moffat, Cambridge (GB)

Correspondence Address: TAROLLI, SUNDHEIM, COVELL & TUMMINO L.L.P., 1300 EAST NINTH STREET, SUITE 1700, CLEVEVLAND, OH, 44114, US

(21) Appl. No.: 11/686,069

(22) Filed: Mar. 14, 2007

(51) Int. Cl. G06F 17/00

(52) U.S. Cl. 707/100; 707/E17.018

(57) ABSTRACT

This invention generally relates to methods, systems, data structures and computer program code for managing spatial data, in particular very large volumes of data such as map data for a region or country. Thus we describe a method of partitioning a database of spatial data, the database including a plurality of spatial feature objections, the method comprising: reading data from said database grid cell-by-grid cell, a said grid cell comprising a cell of a grid spatially subdividing a region of spatial coverage of said database, each said grid cell including spatial feature objects; and determining a set of spatial partitions for said database, each grid cell being allocated to a said partition, responsive to a number of said spatial feature objects in each said grid cell.

### FIELD OF THE INVENTION

This invention generally relates to methods, systems, data structures and computer program code for managing spatial data, in particular very large volumes of data such as map data for a region or country.

### BACKGROUND OF THE INVENTION

Until recently map data comprises little more than image files but recently more powerful techniques for representing maps have emerged based upon a database model in which spatial or geometry data is one aspect of an object which, generally, includes a range of other types of data in particular, for systems developed by the applicant, topological data. This facilitates, for example, rule-based spatial data processing which can be used for a number of purposes including data cleaning, the implementation of mechanisms to ensure data consistency/continuity between different regions or hierarchies of a map, and for searching. A typical implementation employs such as Oracle 9i or 10g which is configured for processing spatial (geometric) data. There are many applications of which one significant category is government—it is important for local or national government to have an accurate, preferably self-consistent map of a country's infrastructure. For many reasons, in particular, of late, homeland security. However such geographical spatial databases typically comprise many millions of objects and even powerful database engines can be slow when searching or otherwise processing the stored data.

There is therefore a need for improved systems for spatial data minute relation. Generally some options for partitioning spatial data include: Tessellation: Starting with a rectangular area, splitting the area up into four tiles, until a level of decomposition is satisfied; the level of decomposition can be based on the number of features per tile. Map Sheets: Features assigned to partitions depending on their map sheet name/number. Regions: Features split into regional partitions e.g., NE, SW, E or Cambridgeshire, Essex etc. Equal Sized Partition Grid: Each partition has same area extent. Manual Density-based Grid: Producing a grid pattern manually based on knowledge of high and low density regions.

One technique employed by the Ordnance Survey MasterMap (registered trade mark) system is simply to divide the country up into a small number of equally sized grid squares and to provide separate data tables for each square. However this approach suffers from the disadvantage that some squares, for example, the square covering London, have very many objects while others, for example, covering Wales, have only a few. Another approach is therefore to use different size grid squares, for example using a collection of smaller grid squares to cover London and larger squares elsewhere. However, this approach requires significant manual intervention and lacks flexibility.

Further background prior art can be found in: U.S. Pat. No. 6,353,832; US2002/0059273; U.S. Pat. No. 6,700,574; EP1043567; Oracle Technology Network: Spatial Overview, 11 Nov. 2004, http://www.web.archive.org/web/20041111083042/http://www.oracle.com/technology/products/spatial/hdocs/spatial_intro/spatial_intro.htm; and S. Nittel et at. “Scaling Clustering Algorithms for Massive Data Sets using Data Streams, ICDE 2003, March 2004, http://www.cs.ucla.edu/˜kelvin/papers/icde03.pdf.

### SUMMARY OF THE INVENTION

According to the present invention there is therefore provided a method of partitioning a database of spatial data, the database including a plurality of spatial feature objections, the method comprising: reading data from said database grid cell-by-grid cell, a said grid cell comprising a cell of a grid spatially subdividing a region of spatial coverage of said database, each said grid cell including spatial feature objects; and determining a set of spatial partitions for said database, each grid cell being allocated to a said partition, responsive to a number of said spatial feature objects in each said grid cell.

This creates a plurality of partitions of the database using the spatial partitions. Implementations of embodiments of the method have provided substantial improvements in data processing speed, for example allowing a geographically based search which would previously have taken many hours, covering perhaps 450 million features, to be completed in less than a second. Embodiments of the method are also very flexible, allowing a partition map to be easily changed depending, for example, on a target number of objects per partition.

In preferred embodiments of the method each partition has approximately the same number of spatial feature objects to within a tolerance such as ±50%, 20% or 10% (or defined in absolute terms such as ±5 million, 2 million, 1 million or fewer objects). In preferred embodiments of the method, therefore, different partition designs are determined for different types of spatial feature, typically stored in different feature tables. Thus a first set of partitions may be determined for a first type of object and a second set of partitions (over the same region) may be determined for a second type of object.

Preferably the spatial feature objects comprise topographical data objects in which case the first and second types of object may comprise, for example, a line object and an area object. Other types of object, such as point, symbol and/or text objects may also be partitioned using the same or different sets of partitions, although generally there are fewer of these types of objects than line and area objects so that the benefits of partitioning may be less pronounced or may even incur an overhead. For example, for Oracle partitioning may not be desirable with less than, say, 10 million objects.

Partitioning can be applied to a sub-section of a country or state or a whole country or state; it will be understood that in general embodiments of the method will be applied to a database comprising at least one million objects, preferably at least five, 10, 50 or 100 million objects.

Preferably the partition determining comprises reading data for each grid cell in turn from the database and keeping a running total of the number of spatial feature objects for a partition until a predetermined size for the partition is reached. At this point a partition identifier such as a partition count, can be allocated to each grid cell before the total is re-set ready for the next partition. The number of objects in a partition may be user determined or may be preset, for example to a value typically greater than one million or greater than 10 million objects or it may be determined automatically, for example dependent upon the total number of objects or database capabilities. Preferably each grid cell is considered in turn in a spatially connected or contiguous sequence so that each partition defines a single, closed shape. Preferably the method also determines spatial boundary data for a partition from spatial data defining the one or more grid cells making up a partition; this may be stored in a table associating coordinates defining the boundary with a partition number or identifier.

The determining of partitions is facilitated by populating a data structure, as the partitions are determined, with, for each grid cell, cell co-ordinates, account for the number of objects in the cell (optionally broken down by type) and a partition identifier for the cell. This facilitates allocation of a partition identifier to each spatial feature object. Thus preferably a data structure is also created in which each spatial feature object is associated with or allocated to a partition. A separate procedure or script may be employed to populate this data structure or table, for example in Oracle (registered trade mark) a PL/SQL script. This, in effect, creates a plurality of separate partitions of the database using the determined partition boundaries. Optionally one or more rules may be employed for determining to which partition an object should be allocated where, say, an object crosses a boundary between two partitions. Preferably, to further facilitate processing of the stored data, each partition is stored as a separate file at the operating system level, although (preferably) logically they make up a single unified data structure or table.

The grid defining the grid cells from which data is read is preferably a regular grid such as a rectangular or square grid. The grid may be provided by data input to the database—for example UK Ordnance Survey data is provided in five kilometre squares—or a grid may be defined automatically or manually. For example the size of the grid (spacing of the grid lines) may be determined by a count or number density of features (of the type to be partitioned). This process may be interactive, for example a user provisionally selecting or defining a cell size and optionally revising this upon a counted number of objects in the cell or per partition.

In a related aspect the invention provides a method of managing data in a database of spatial data, the database including a plurality of spatial feature objects, the method comprising: aggregating a group of grid cells, a said grid cell comprising a cell of a grid spatially subdividing a region of spatial coverage of said database, into a single geometric object; storing data for said geometric object in said database; and repeating said aggregating to define a plurality of said geometric objects each comprising a group of a plurality of grid cells.

Preferably the method further comprises determining the group of grid cells to aggregate, in particular responsive to a number density or count of the spatial feature objects.

The invention further provides a carrier carrying processor control code to implement embodiments of the above-described method, and a data processing system or database including this code. The carrier may comprise a disk, programmed memory such as read-only memory, or an optical or electrical signal carrier. The code may comprise code in a conventional programming language (which may be compiled or interpreted), which includes one or more scripts such as SQL scripts. Thus, in embodiments, the code is implemented as part of a database system. The code may be provided in a plurality of separate scripts and, as the skilled person will appreciate, may be distributed between a plurality of coupled components in communication with one another, for example on a network.

In a further aspect the inventions a database of spatial data for a region, the database having at least one data structure comprising a set of topological objects and including a plurality of spatial partitions of said region; wherein each said object has associated data identifying a said partition within which the object is spatially located.

Preferably the database has two (or more) data structures, one for each type of topographical object, for example an area feature table and line feature table. Preferably the database further comprises a partition data structure including spatial data such as co-ordinate data defining partition boundaries. For example the boundary of a partition may be defined in a piecewise linear fashion using co-ordinates of a plurality of linear line segments, or by identifying or defining the boundary using grid cells; in general a partition has a non-regular shape. Preferably each partition includes approximately the same number of topological objects, at least to within a tolerance of, for example, ±50%.

The database may be used for searching by, for example, inputting a search request relating to a spatially defined area and identifying one or more of the partitions to which the search request relates (this may be intrinsic to the database operation), then searching the identified partitions. In this way a database with one, 10, 100 million or more objects may be searched rapidly. As a skilled person will understand such a database can often be distributed over a plurality of computer systems, for example on a server farm.

### BRIEF DESCRIPTION OF THE DRAWINGS

These and other aspects of the invention will now be further described, by way of example only, with reference to the accompanying figures in which:

FIG. 1 shows examples of how topological map data is stored in a database;

FIGS. 2a and 2b show a flow diagram of procedures for determining a cellular grid, determining a set of partitions, and generating a partition data table and updating area and line feature tables with partition data; and

FIG. 3 shows an example of a grid table;

FIG. 4 shows an example of a grid square table for a small example spatial dataset;

FIG. 5 shows an example of aggregation in individual grid cells (on left) into partition extents (on right);

FIG. 6 shows a hardware block diagram of a database system incorporating scripts and tables to implement the procedures of FIG. 2.

### DETAILED DESCRIPTION OF PREFERRED EMBODIMENTS

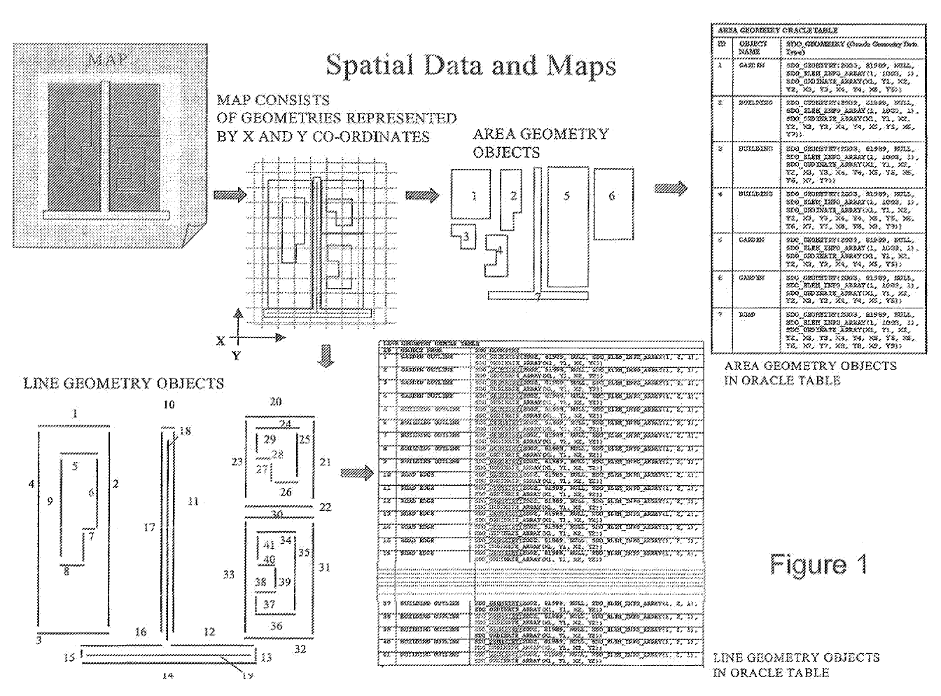

We first describe, by way of background, how map geometries are stored in Oracle™. As illustrated in FIG. 1, the geometries displayed on the map are stored in one or more Oracle™ tables. Each feature on a map can be made up of several area/polygon objects of multiple line objects. Each geometry object has associated X and Y co-ordinates for each vertex of the geometry, so we know where the feature exists in the real world and therefore where the feature will be displayed on a map.

In FIG. 1, a building on the map can be stored in Oracle as one area/polygon object and/or as several line objects, where each line represents an outer-wall of the building. The area/polygon representation of the building is stored in a separate Oracle table to the line objects.

We next describe databases and partitioning. The database tables that hold all of the area and line geometries can get very large. For example, there are over 262 million line geometries for the England and Wales Ordnance Survey MasterMap® product.

If all of these line features are stored in one normal table in Oracle, it will take the database a long time to find a particular feature of interest. Even with an index on the large table it still takes Oracle a long time to propagate through the index entries to find the exact feature to which a search is directed. By way of analogy it takes a longer time to find your hometown in a world atlas than it does in a regional road atlas index, because the regional road atlas index is a lot smaller with fewer entries.

Oracle provides partitioning functionality to allow fast searching through large table. Partitioning splits the table into sections called partitions. Determining which object is stored in which partition is carried out by the value stored in the partition key column of the Oracle table. Each partition can then have its own index. So when searching for a particular feature, Oracle determines which partition this feature is in (or data can be manually input to tell Oracle which partition the feature is in, by specifying the feature's partition key), and Oracle only has to search through the index of that particular partition, thus finding the object much faster. This is like splitting a world atlas into individual regional chapters, where each regional chapter has its own index; to find your hometown, you go straight to the chapter's index.

We now describe partitioning spatial data. The majority of spatial data applications and services will query the data using some sort of spatial query. For example “find the number of houses within a school's catchment area”, or “display all geometries within a specified area extent”.

To find these spatial objects Oracle uses spatial indexes, which index the objects based on, where they are in co-ordinate space, so objects that are adjacent to each other on a map are adjacent to each other in the index. We therefore partition the spatial data based on spatial location, so where an object is in space determines which partition stores the object.

However the Oracle database presents the spatial data users with a limitation. You cannot partition data based on the actual object's geometry column (which stores the X and Y co-ordinate information), so another partition key column needs to be created, to represent where an object is spatially, and what partition will store the object.

In addition to this, it is also desirable for performance contains roughly the same amount of features. It is also desirable for performance reasons to choose a good compromise number of partitions, as there is a performance impact if the number of partitions and the size of the partitions are too large/small.

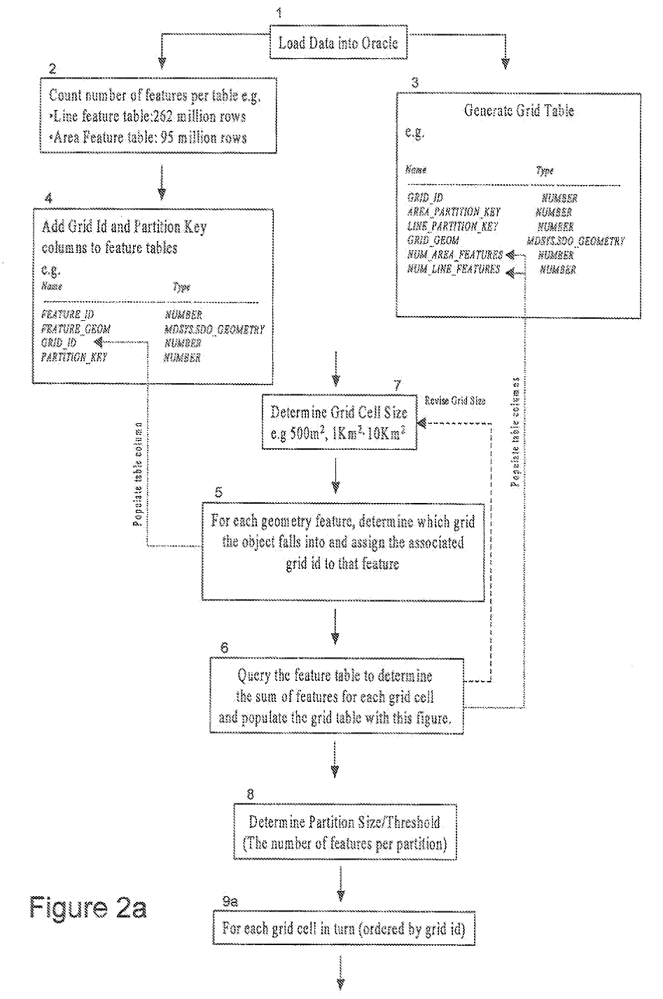

We now describe data partitioning partition steps for a preferred embodiment of the invention, as illustrated in the flow diagram of FIGS. 2a and 2b. The numbers below refer to the labelled steps in the figure:

1. Load map feature data into normal non-partitioned Oracle tables using a loading tool such as FME (Feature Manipulation Engine) from Safe Software Inc., of Canada.

2. Count the number of (line/area) features per table. This pre-processing step is preferably used to determine one or more of:

(a) Which tables need partitioned: Tables above a certain size may benefit from partitioning. This is a database performance decision, where the threshold that determines whether a table is partitioned is decided through testing of other database.

(b) The (spatial) co-ordinate extents of the data to be partitions. Preferably taking into consideration the possible growth of the data and then extending partition design slightly beyond a current data extent, for future updates—although partitions can also be added to existing tables to accommodate future inserts.

(c) Number of partitions per table and number of objects per partition. These are performance decisions which can be based on testing.

3. Generate a Grid table (having determined an initial cellular grid size, see step 7 below). At the end of the partitioning map generation process, this table will contain information on number of features per grid, partition key assigned to objects that fall within the grid square and a unique grid id (including grid co-ordinate/geometry).

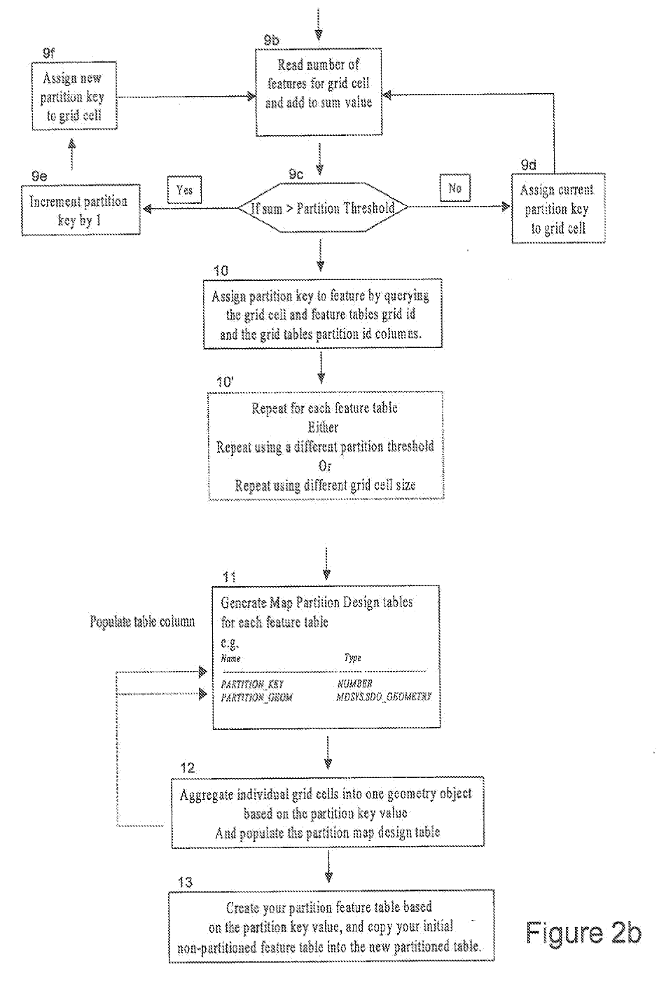

An example of the columns that can be found in the grid table, and what this grid table would look like displayed as geometry objects, is shown in FIG. 3. This grid in effect overlies the map.

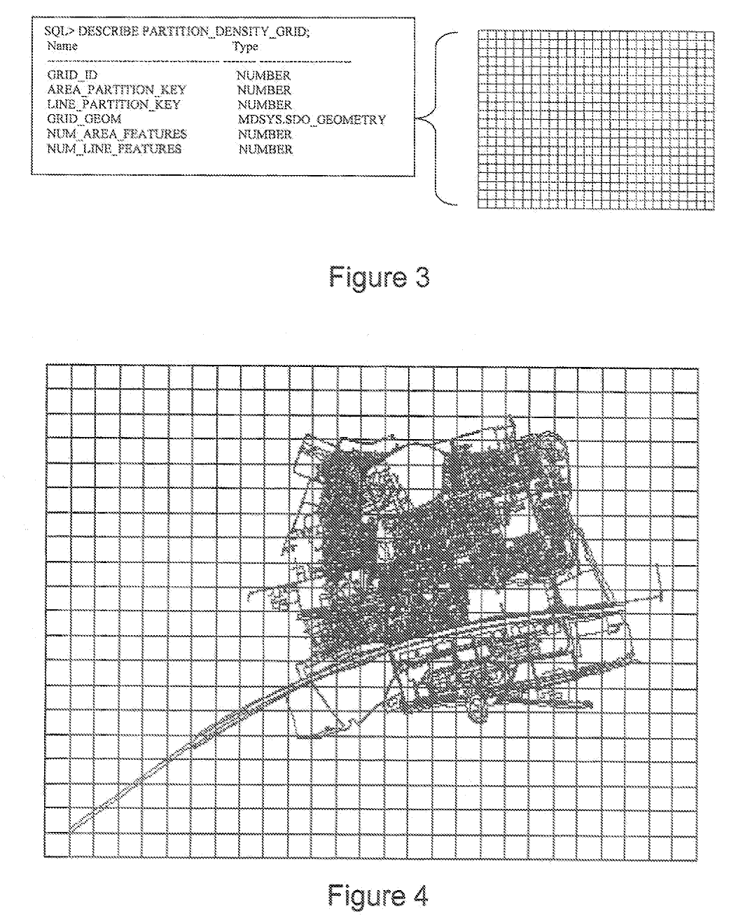

The size of the grid square will reflect the accuracy of the number of features per partition (i.e., how close to a target number of features is achieved). The smaller the grid square, the more accurate the partition map designs. The number of features per partition is to the nearest grid square object count. FIG. 4 illustrates a grid table for a small sample dataset with, in this example, grids 100 m² in size.

A separate grid table can be generated per feature table (for example for lines and areas), or the same grid pattern can be used for all feature tables as in the example of FIG. 3.

4. Add a grid id column and a partition key column to the feature table that is to be partitioned. Every geometry object will have an associated grid id and partition id.

5. For each geometry feature, determine which grid the object falls into and assign the associated grid id to that feature. If the feature crosses more than one grid cell, the feature is assigned to the minimum grid id.

6. Query the feature table to determine the sum of features for each grid cell and populate the grid table with this figure.

7. Determine whether the density of features per grid cell is acceptable, since the accuracy of partitions will be to the closest grid cell feature count. If a different grid feature density is preferred, then create a new grid table with new grid cell size (step 3) and repeat steps 5 and 6.

8. Determine partition size (number of features per partition, referred to later as a partition threshold value; this may be different for line and area functions).

9. For each grid cells in term (9a), read into a PL/SQL function the number of features per grid cell, ordered by grid id value and add to a sum (9b). If the command number of feature is less than a partition threshold value (9c), than assign a partition key to grid cell (9d).

The number of features per partition will be closest to a multiple of the average number of features per grid cell. Once the partition threshold is reached increment the partition key by one (9e,f).

10. Using the grid id column in the feature table, populate the corresponding feature partition key column, by querying the grid cell table grid id and partition id columns. Optionally repeat (10¹) for each feature table (line/area), optionally using a different grid cell size and/or position threshold. The result is a populated map partition grid table.

11. Generate a map partition design table, to hold the partition key and partition geometry (e.g., co-ordinates defining partition boundaries).

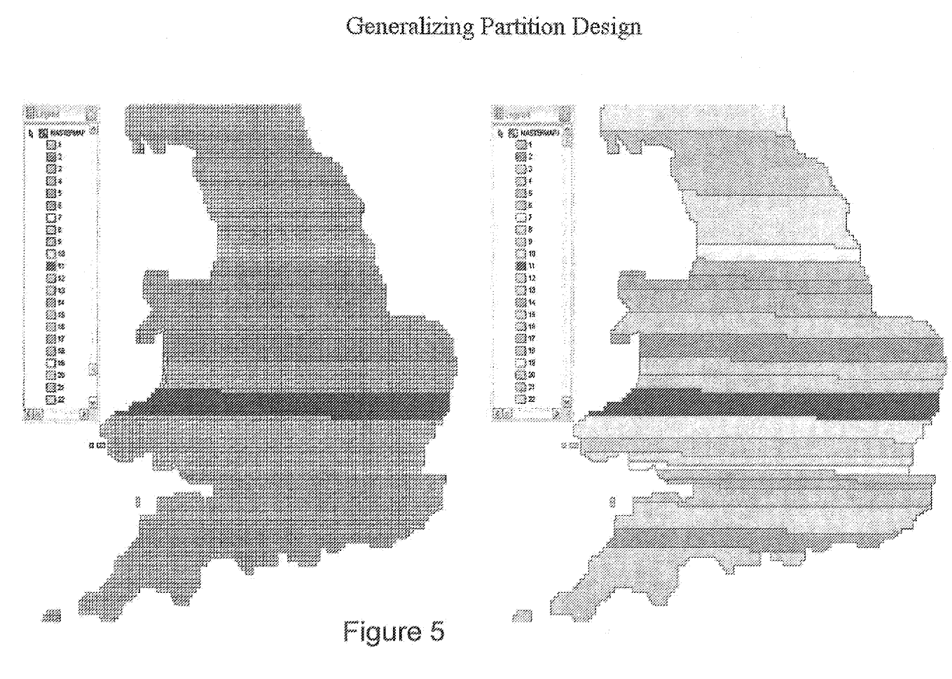

12. Aggregate individual grid cells into one geometry object based on the partition key value and populate the partition design table. An example of a map partition design is illustrated in FIG. 5.

13. Create a partition table based on the partition key value, and copy the initial non-partitioned table into the new partitioned table (determine, for each feature, into which partition it falls using table of partitions). Optionally split line/area feature tables into files at the operating system level.

In one example an Oracle table was generated which contained each Ordnance Survey MasterMap® sheet name, sheet boundary (min x, min y, max x, max y), the number of area objects per file, the number of line objects per file an area partition key column and a line partition key column.

An Oracle PL/SQL function was used to design the partition map (the design of the partition can be based on either OS sheet name order, or OS file extent order). Each sheet along with its boundary extents and number of objects is passed info this PL/SQL function.

This function reads-in each OS sheet name, or OS sheet extent and the number of either area or line features in the sheet, and assigns an associated partition key into the associated partition key column until the required number of objects per partition is reached. Once the required number of objects per partition is reached the partition key is then incremented by one and this incremented partition key is assigned to the next sheet or extent read-in.

The number of objects per partition is achieved to the nearest number of object per OS file. If the next file read-in causes the number of objects to increase beyond the specified value the partition key is incremented by one.

An example of the PL/SQL code (for area features) is shown below, where each partition will hold (to the nearest file object count) 8 million objects.

| | |
|---|---|
| DECLARE | |
| i | NUMBER; |
| j | NUMBER; |
| subtotal | NUMBER; |

```
      part_key NUMBER;
BEGIN
      j:=0;
      subtotal:=0;
      part_key :=1;
    FOR REC IN (SELECT MINX, MINY, num_area_toid,
partition_key FROM area_partition_3 order by MINY, MINX)
    LOOP
          subtotal := subtotal + REC.num_area_toid;
          UPDATE area_partition_3 a SET a.partition_key = part_key
WHERE a.MINY=REC.MINY AND A.MINX=REC.MINX;
        IF subtotal >8000000 THEN
            dbms_output.put_line(‘partition is ’||part_key);
              subtotal := 0;
              part_key :=part_key +1;
            END IF;
    END LOOP;
END;
/
```

The function reads-in each file and assigns the nth partition key to that file until the sum of the number of area objects (num_area_toid) reaches 8 million. The next file read-in is assigned a new partition key n+1, again until the sum of number of objects reaches 8 million, and so forth.

Each sheet boundary extent (min x, min y, max x, max y) is then transformed into an Oracle Spatial SDO_GEOMETRY object.

The individual file boundaries are then merged based on the partition key value, using the Oracle Spatial SDO_AGGR_UNION function. For example all the individual OS files, which have the same partition key assigned to them are merged into one geometry object.

This partition geometry object can then be used in the Oracle Spatial SDO_RELATE function to assign a partition key to each object.

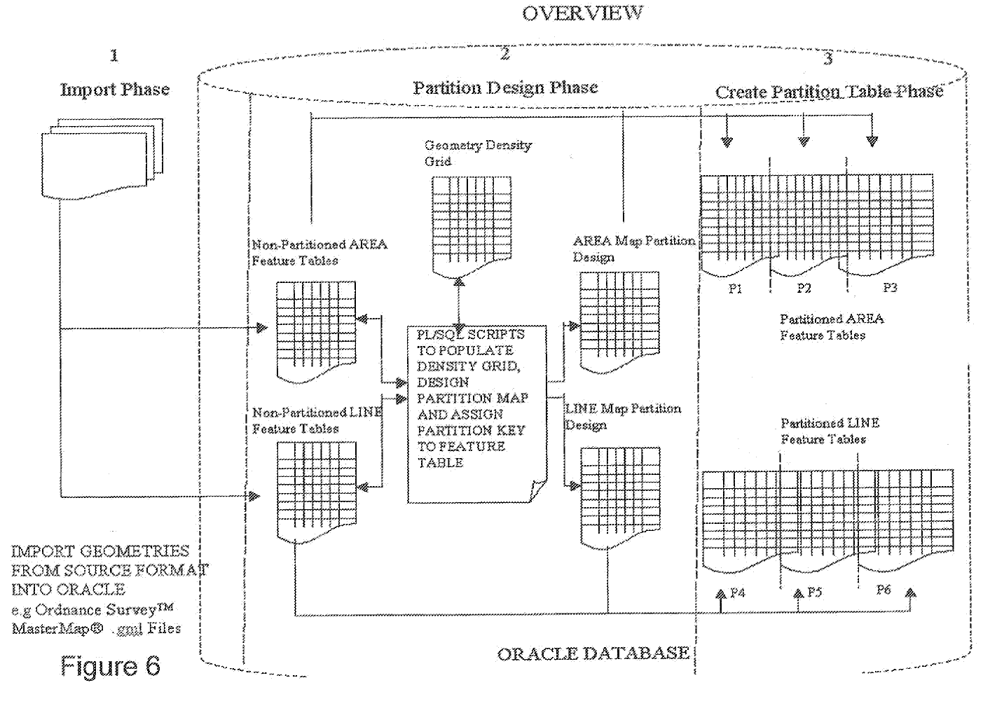

FIG. 6 shows an overview of partition map creation, showing the three main stages:

1. Import of features into normal Oracle table;

2. Use of PL/SQL procedures to create partition map(s) and assign partition keys to Individual geometry objects; and

3. Population of a partitioned table based on individual geometry features partition keys.

We have described a fast and dynamic method to generate partition maps. This method can be used to generate partition maps for data from any region in the world, where each feature table can have its own partition map based on number and density of objects stored in the particular feature table. There is no need for detailed knowledge of the density of data, and there is no need to create a spatial index on the non-partitioned initial load table in order to assign a partition key to each feature. In embodiments only one spatial function is carried out against the spatial data table during the partition map creation process, thus minimising partition creation time.

The accuracy of the partition density can be determined beforehand (accuracy in terms of how close the actual number of features per partition are to the required numbers of features per partition), where the less accurate the partition density design, the faster the partition map generation process. It is also possible to try different partition models because the number of features per partition, and the partition layout can be determined without having to partition the actual feature table.

No doubt many other effective alternatives will occur to the skilled person. It will be understood that the invention is not limited to the described embodiments and encompasses modifications apparent to those skilled in the art lying within the spirit and scope of the claims appended hereto.

I claim:

1. A method of partitioning a database of spatial data, the database including a plurality of spatial feature objections, the method comprising:
reading data from said database grid cell-by-grid cell, a said grid cell comprising a cell of a grid spatially subdividing a region of spatial coverage of said database, each said grid cell including spatial feature objects; and
determining a set of spatial partitions for said database, each grid cell being allocated to a said partition, responsive to a number of said spatial feature objects in each said grid cell.

2. A method as claimed in claim 1 wherein said spatial feature objects comprise topographical data objects including at least a first type of object and a second type of object; and wherein said determining comprises determining a first set of partitions responsive to a number of said first type of object in each cell and determining a second set of partitions responsive to a number of said second type of object in each cell.

3. A method as claimed in claim 2 wherein said first type of object comprises a line object and said second type of object comprises an area object.

4. A method as claimed in claim 1 wherein said determining comprises reading data for each said grid cell in turn from said database and adding said number of spatial feature objects for a grid cell to a running total for a partition until a partition size is reached, to determine a said spatial partition.

5. A method as claimed in claim 4 wherein said determining further comprises determining spatial boundary data for a said partition from spatial data defining one or more grid cells having objects contributing to said running total for the partition.

6. A method as claimed in claim 4 wherein said determining comprises populating a data structure comprising data defining for each said grid cell, coordinates of the cell, a count of a number of said feature objects in the cell, and a partition identifier for the cell to identify a partition within which the cell is located.

7. A method as claimed in claim 1 further comprising creating and storing data associating each said spatial feature object with a said partition.

8. A method as claimed in claim 1 further comprising creating a data structure defining a spatial boundary of each said partition.

9. A method as claimed in claim 1 further comprising dividing stored spatial data for said objects into a plurality of files at the operating system level, one for each said partition.

10. A method as claimed in claim 1 further comprising determining said grid.

11. A method as claimed in claim 1 wherein there is at least one million said objects, at least 10 million or at least 100 million said objects.

12. A carrier carrying processor control code to, when running, implement the method of claim 1.

13. A data processing system or database Including the code of claim 12.

14. A method of managing data in a database of spatial data, the database including a plurality of spatial feature objects, the method comprising:
aggregating a group of grid cells, a said grid cell comprising a cell of a grid spatially subdividing a region of spatial coverage of said database, into a single geometric object;
storing data for said geometric object in said database; and
repeating said aggregating to define a plurality of said geometric objects each comprising a group of a plurality of grid cells.

15. A database of spatial data for a region, the database having at least one data structure comprising a set of topological objects and including a plurality of spatial partitions of said region; wherein each said object has associated data identifying a said partition within which the object is spatially located.

16. A database as claimed in claim 15 having two said data structures, a first comprising a set of topological objects of a first type and a second comprising a set of topological objects of a second type, each having a separate said spatial partition.

17. A database as claimed in claim 15 further comprising a partition data structure including spatial data defining a spatial boundary of each said partition.

18. A database as claimed in claim 15 wherein each said partition includes the same number of said topological objects to within a tolerance of ±50%.

19. A method of searching the database of claim 14, the method comprising:
inputting a search request relating to a spatially defined area;
identifying one or more of said partitions to which said search request relates;
searching said identified partitions.

20. A carrier carrying processor control code to, when running, implement the method of claim 19.

21. A data processing system for partitioning a database of spatial data, the database including a plurality of spatial feature objections, the system comprising:
a system to read data from said database grid cell-by-grid cell, a said grid cell comprising a cell of a grid spatially subdividing a region of spatial coverage of said database, each said grid cell including spatial feature objects; and
a system to determine a set of spatial partitions for said database, each grid cell being allocated to a said partition, responsive to a number of said spatial feature objects in each said grid cell;
wherein said spatial feature objects comprise topographical data objects including at least a first type of object and a second type of object; and wherein said system to determine said set of spatial partitions is configured to determine a first set of partitions responsive to a number of said first type of object in each cell and to determine a second set of partitions responsive to a number of said second type of object in each cell.
